(19) United States
(12) Patent Application Publication
(10) Pub. No.: US 2008/0005957 A1
(43) Pub. Date: Jan. 10, 2008

(54) Handling and blending of biodiesel

(75) Inventors: Amy Sell, Indianapolis, IN (US); Todd Coffman, McComb, OH (US); Bernard M. Sharkey, Murfreesboro, TN (US); Russell P. Lewis, Flatwoods, KY (US); Andy Lester, Huntington, WV (US); Douglas W. Fowler, Bluffton, OH (US)

Correspondence Address: EMCH, SCHAFFER, SCHAUB & PORCELLO CO, P O BOX 916, ONE SEAGATE SUITE 1980, TOLEDO, OH, 43697, US

(73) Assignee: Marathon Petroleum Company LLC

(21) Appl. No.: 11/481,746

(22) Filed: Jul. 5, 2006

(51) Int. Cl. C10L 1/04; B01F 15/02

(52) U.S. Cl. 44/308; 366/167.1

(57) ABSTRACT

This handling relates to the effective storage and blending of biodiesel with petroleum fuel. More specifically, the processing relates to blending biodiesel with petroleum based diesel fuel stocks in cold weather without shock crystallization.

### TECHNICAL FIELD

This invention relates to the effective storage and blending of biodiesel with petroleum fuel. More specifically, the invention relates to blending biodiesel with petroleum based diesel fuel stocks in cold weather.

### BACKGROUND OF THE INVENTION

Biodiesel is the name for a variety of ester-based oxygenated fuels made from vegetable oils, fats, greases, or other sources of triglycerides. It is a nontoxic and biodegradable substitute and supplement for petroleum diesel. Even in blends as low as 20% biodiesel to 80% petroleum diesel (B20), biodiesel can substantially reduce the emission levels and toxicity of diesel exhaust. Biodiesel has been designated as an alternative fuel by the United States Department of Energy and the United States Department of Transportation, and is registered with the United States Environmental Protection Agency as a fuel and fuel additive. It can be used in any diesel engine, without the need for mechanical alterations, and is compatible with existing petroleum distribution infrastructure. Various states also have mandated that distillate sold for use in internal combustion engines must have a minimum of 2 percent biodiesel, a B2 blend. Blending warm biodiesel with cold distillate can result in the formation of wax crystals which may lead to product quality concerns.

### SUMMARY OF THE INVENTION

We have developed a biodiesel handling and blending system using varying parameters of biodiesel/distillate blend ratio, temperature, and amount of mixing occurring in the batch, to obtain positive results. The results showed that when zero (0) degree petroleum distillate was blended with fifty (50) degree biodiesel, and thoroughly mixed; the resulting homogeneous blend did not contain wax crystals. The results also showed that once the biodiesel had been distributed homogeneously throughout the sample, the resulting mixture exhibited properties more like a petroleum distillate than like a methyl ester.

A phenomena known as “shock crystallization” (formation of wax crystals) occurs when blending biodiesel with petroleum diesel at low temperatures. Based on experimental results, B100 splash blending with base fuels at temperatures of less than 10° F. causes wax formation when making a B2 blend. To successfully make a B2 blend without “shock crystallization”, we have invented a system wherein one of two things must be done:
Heat the base fuel to a minimum temperature>10° F. and blend using B100 at ˜50° F.; or
Agitate the ˜0 ° F. mixture during the B100 addition using a pump or static mixer.

In addition, some B5 and B20 scenarios were attempted. These results, as well as those from the B2 blends, are further detailed in this patent.

This invention presents analytical results for the blending of 100% biodiesel with petroleum diesel fuel at low temperatures (˜0° F.), in order to obtain a 2% biodiesel blend with little or no wax formation. While other blend scenarios were considered, the main focus will be on the B2, and the conditions that must present to allow for a wax free blend.

### BRIEF DESCRIPTION OF THE DRAWINGS

FIG. 1 is an overall mechanical site plan showing an apparatus for producing biodiesel distillate blends.

FIG. 2 is a plan view showing the location layout for tanks and off-load station in accordance with the present invention.

FIG. 3 is a plan view showing piping details for the location layout of FIG. 2.

FIG. 4 is a plan view showing piping details in greater detail for the location layout of FIG. 2.

FIG. 5 is an isometric view of proposed piping for lanes in the location layout of FIG. 2.

FIG. 6 is an isometric view of ratio style blending (B20) in accordance with the present invention.

FIG. 7 is a shows Table I which provides a detailed analysis of the pure biodiesel, petroleum diesels, and blends of each used in this invention.

FIGS. 8 and 9 show Tables which detail the effects of biodiesel on cetane, lubricity, cloud point, pour point, and CFPP.

### DETAILED DESCRIPTION OF THE INVENTION

Preferably, the diesel fuel is a liquid fuel for Diesel engines. The Diesel fuel used to obtain the fuel according to the present invention can be Diesel fuel for automotive applications but also a Diesel fuel for different uses, including arctic Diesel fuel and winter Diesel fuel.

The components of the biodiesel may vary widely. Soybean oil or soy oil is a most widely used vegetable oil for both edible and industrial uses. The most common ester of soybean oil is the methyl ester.

Numerous experiments were conducted considering many different biodiesel blend scenarios. Several solutions to the biodiesel “shock crystallization” effect have been discovered, and are detailed below.

### Splash Blend Method

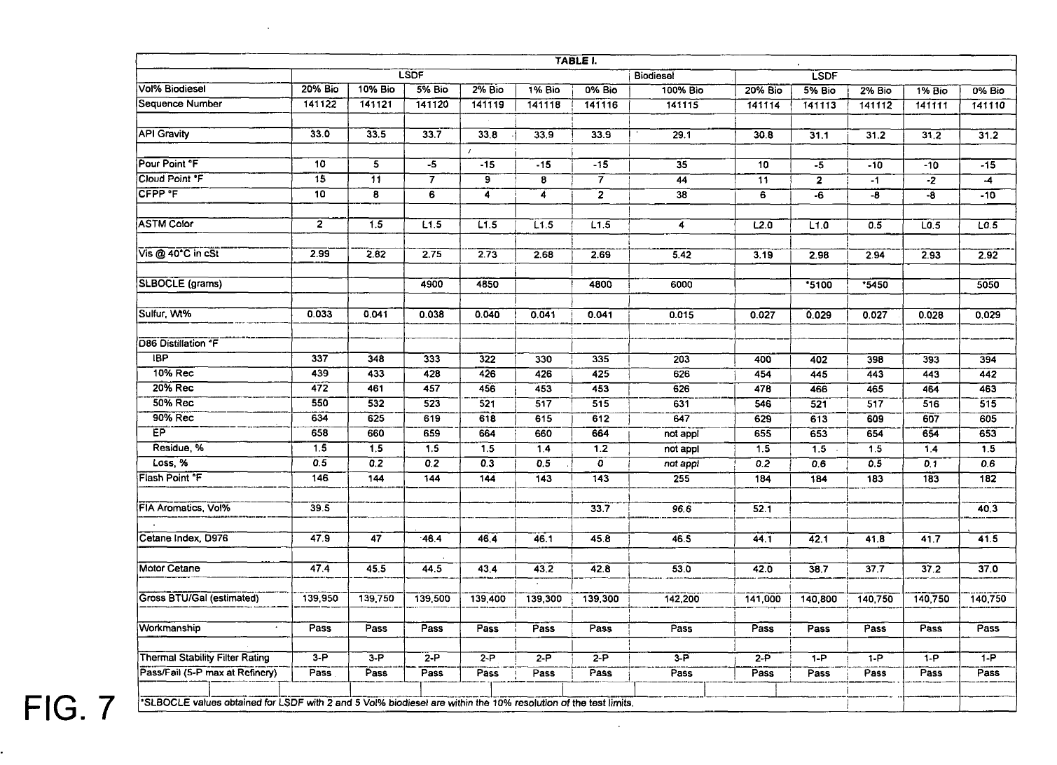

Blending B100 at 50° F. with a 0° F. base fuel (consisting of a 70/30 #2 LSDF/#1 fuel oil mixture) without agitation, making a B2 blend, results in “shock crystallization”. The wax that formed in the 0° F. B2 splash blends stayed in solution for an extended period of time, without ever dissolving. When the temperature of the base fuel was raised to between 10-20° F. the B100 blended successfully without wax formation. This means that base fuel temperatures must be kept at a minimum temperature >10° F., before a B2 blend can be made without the formation of wax crystals. The B20 blends were inconclusive based on the presence of water crystals in solution. This could have been brought on by stirring or the elevated temperature of the B100, which was 80° F. prior to addition (the effects of humidity and cause of water crystals in solution is further detailed later in this report). The results in Table I of FIG. 7 further detail the results of the B100 blending without the use of agitation for both B2 and B20 blends.

### Pump and Static Mixer Simulation Method

Two agitation methods were used, and proved successful in providing an accurate depiction of what could happen if a pump or static mixer were present. A paddle mixer, ranging from 800-1700 rpm, and a handheld Braun mixer, shearing at 12,000 rpm, showed that agitating the mixture for an amount of time based on rpm and fuel temperature resulted in the elimination of wax crystals. The 12,000 rpm shear worked very well in reducing/eliminating wax crystals. Several different blend combinations were used with the high rpm agitation, with most yielding a clear, wax-free solution. A paddle mixer, ranging in rpm from 800-1700, with an 85° blade, was used to mimic the agitation seen in a properly designed static mixer. The results of testing show that at 1700 rpm, a B2 blend (blending B100 at 500 with a base fuel at 0-5° F.) mixes successfully with 5-7 seconds of agitation and 2-5 minutes of settling time. This particular run did not show immediate wax dissipation after blending, but very few wax crystals formed, which let to a short dissolve time after agitation. At 800 rpm, 10-12 seconds of agitation and 2-5 minutes settling time was needed to make a B2 blend under the same biodiesel and base fuel conditions. Agitation time could have been increased to the point where the wax was fully dissolved. But, designing a static mixer to reproduce those agitation conditions would have been costly and impractical, if not impossible. The goal was to find a set of conditions that would lead to a successful B2 blend and, at the same time, optimize both cost and design.

### Effects of Humidity

Throughout the testing, wax and water crystals (when present) were often confused and led to several inconclusive or failed experiments. With the realization of the effect of high humidity on low temperature fuels, several approaches were taken to rectify water crystal formation. They include:
All experiments were conducted on days of medium to low humidity (30% or less).
Continual stirring was not performed on the base fuels while cooling in ice bath. This prevented air moisture from being “funneled” into solution.
All base fuel solutions were covered and brought to 0° F. gradually.

### With the implementation of these new procedures, the base fuel was relatively water free, which made the determination of wax crystal formation more accurate.

Several different blending methods can be used to successfully blend biodiesel with petroleum diesel fuel at low temperatures to avoid “shock crystallization”. Splash blending, as well as blending with some type of agitation, can be used to make specific biodiesel blends, most notably B2 blends, with minimal to no wax crystal formation. This “shock crystallization” can be prevented when blending under a set of conditions specific to the method above.

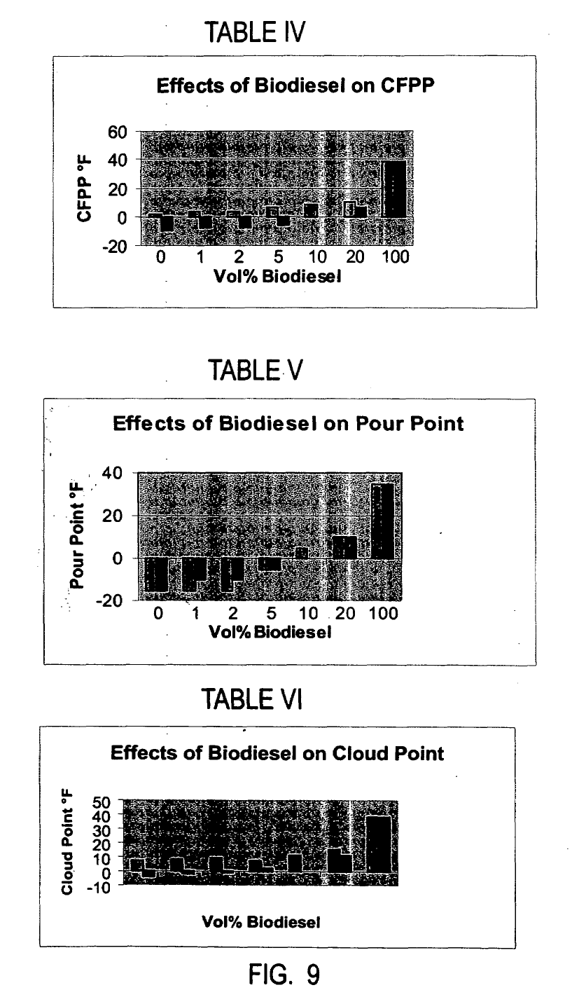

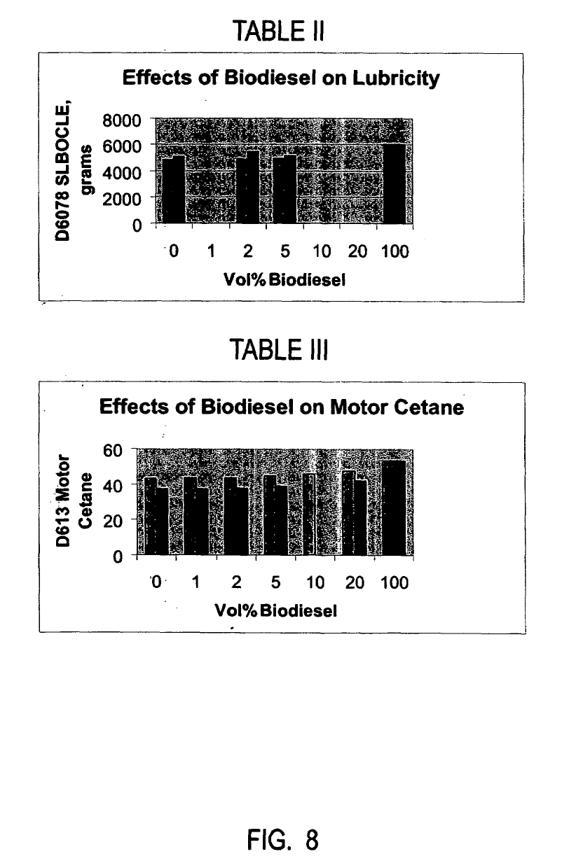

The results in the Tables of FIGS. 8 and 9 further demonstrate the desired effect of this invention.

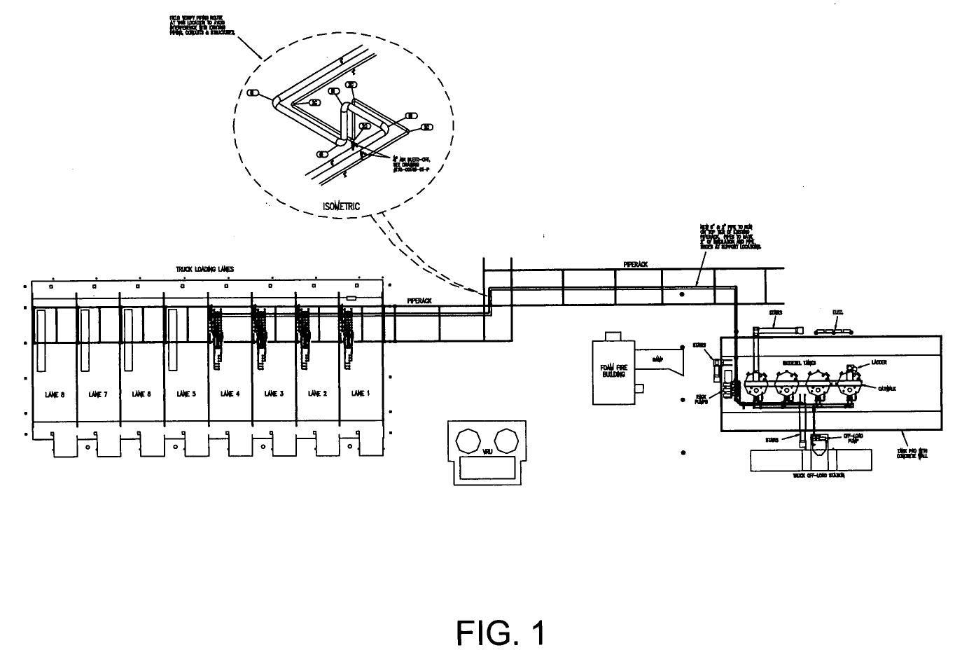

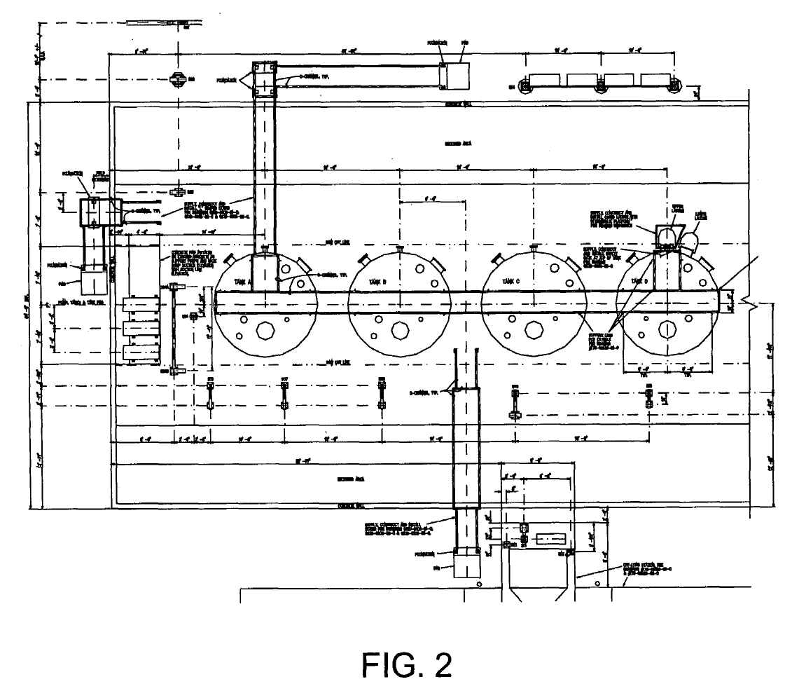

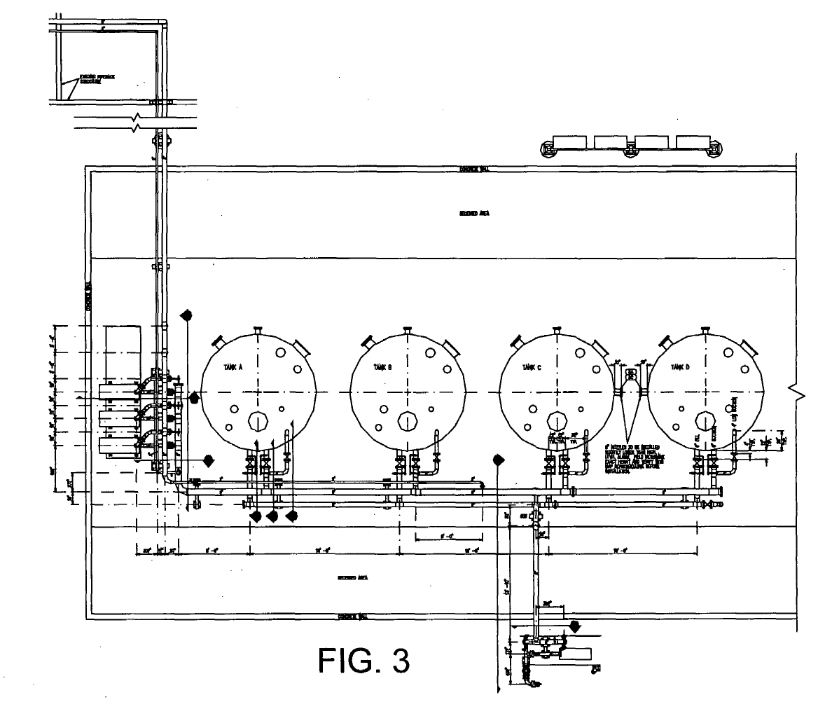

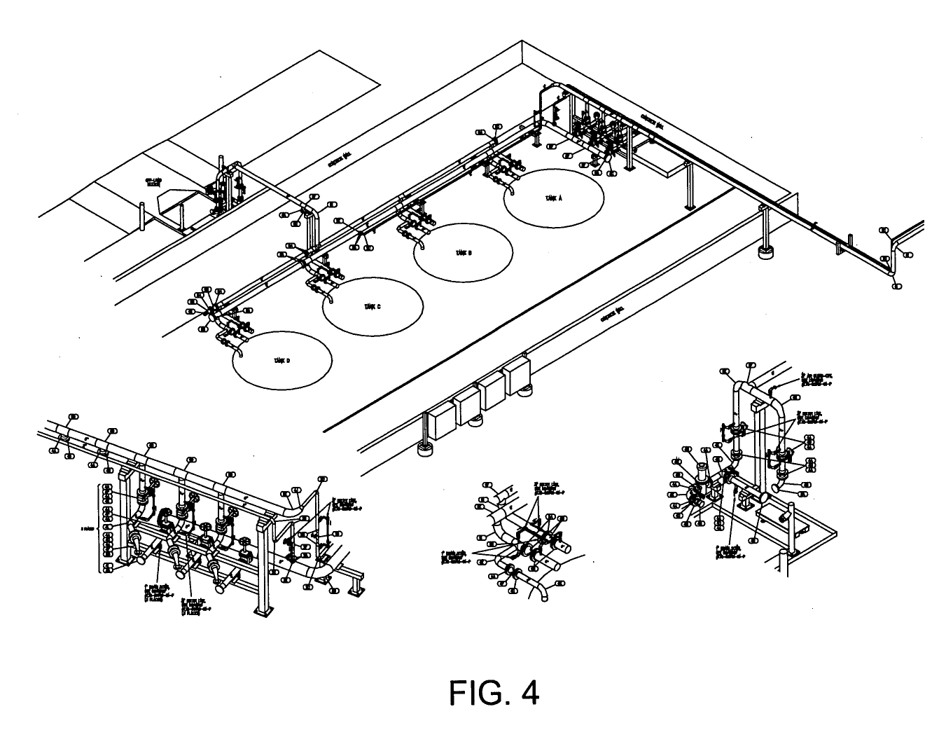

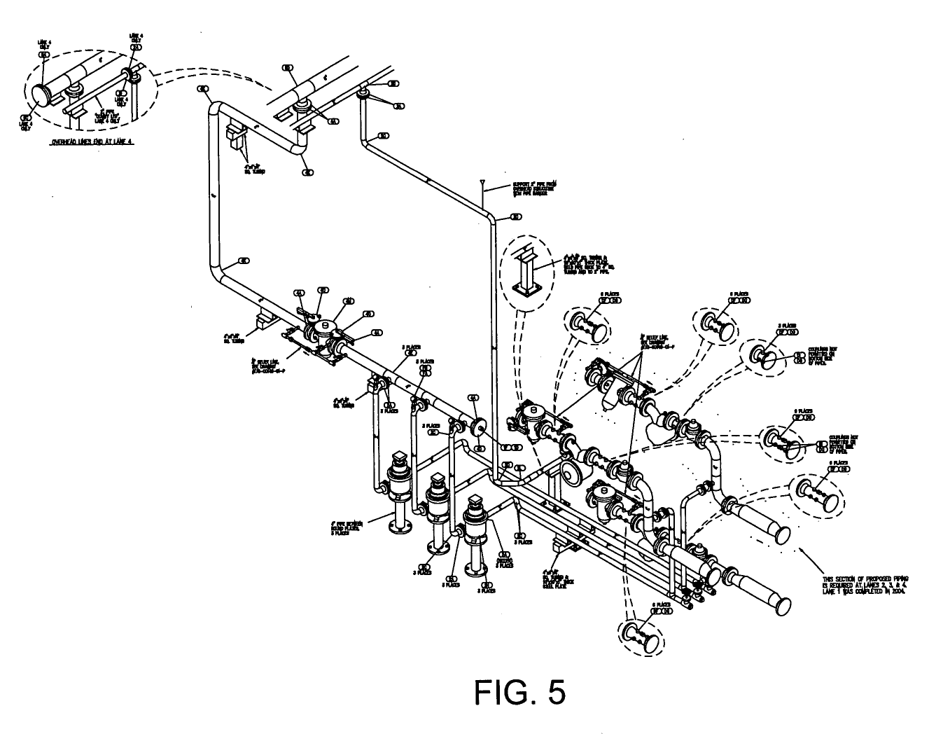

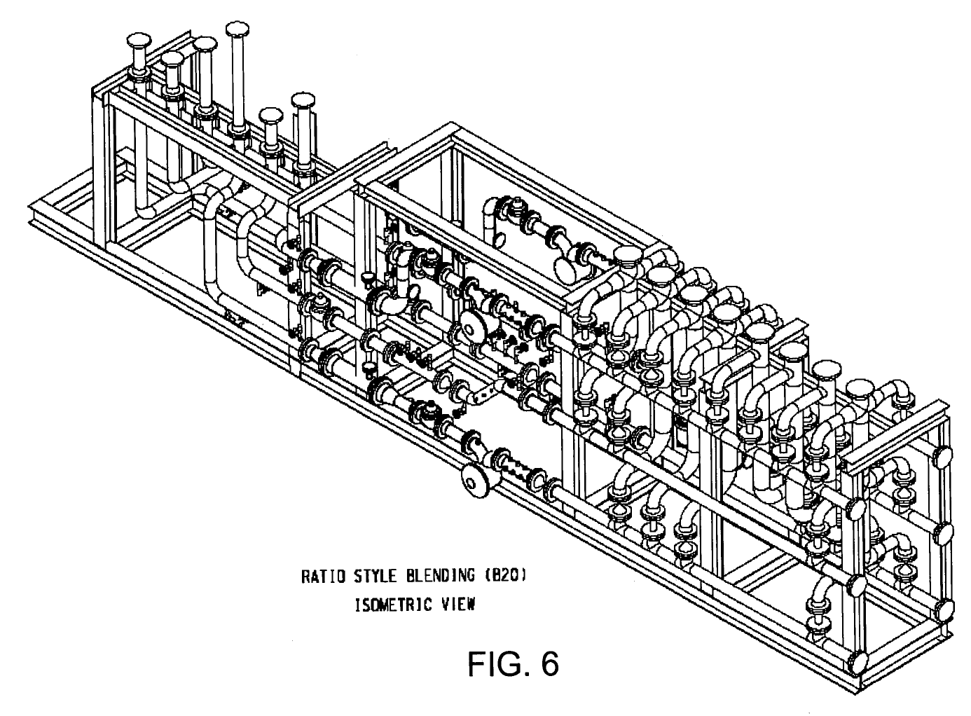

FIGS. 1 to 6 show the Biodiesel Handling/Blending Apparatus Design of this invention

### Installation of the Following Components:

### Biodiesel Storage:

1. Tanks—Install (4) four new 40,000 gal shop-built biodiesel tanks, approximately 14″ in diameter and 33′9″ tall, with the following openings: One 24″ Shell Manway with hinge and handle, ½″ cover, ⅜″ neck and flange. One 24″ UL style roof Manway. One 8″ 150#Flanged Nozzle for Normal Vent. One 6″ 150# Flanged Nozzle for Low Suction. One 6″ 150# Flanged Nozzle for Fill. One 6″150# Flanged Nozzle for Mixer. One 6″ 150# Flanged Nozzle for Heater. One 4″ 150# Flanged Nozzle for High Level Alarm. One 6″ 150# Flanged Nozzle for ENRAF. One 6″ 150# Flanged Gauge Hatch. Five 1″ 3000# Full Couplings.

2. Tank Heaters—The 150 kW tank heater shall be installed in the above tank and designed to maintain the tank temperature at 65 degrees F. The heater has the capacity to raise the product temperature in one tank by 50 degrees F. in 10 minutes.

3. Tank Mixer—The Tank mixer shall be mounted at a 7 degree angle, inside a 6″ nozzle on the tank. The mixer will provide horizontal mixing across the tank, and will be able to maintain a consistent temperature throughout the tank (±2 degrees), however, the mixer should not be relied upon to circulate and mix product vertically throughout the tank. A limited amount of vertical tank mixing should be expected through regular diodiesel receipts and delivery.

4. Tank Insulation—The tank shall be insulated with approximately 4″ of standard tank insulation.

5. Gauging/Instrumentation—Two (2) ENRAF tank gauges will be installed to monitor the product level in the biodiesel tanks. Each storage tank will also have an individual Magnetrol/HLA, which will provide overfill protection for each tank. These monitoring systems will be tied into the existing refinery tank gauging system.

6. Containment—The tanks shall be installed on a concrete tank pad, approximately 50′×86′. Concrete dike walls will be installed around the perimeter of the tank pad and shall be 4′ high. Pumps are mounted inside the concrete dike area, and anchored to the concrete tank pad.

7. Containment Access—The concrete containment area shall have (2) two sets of stairs going up, over, and down into the tank bottom. An additional set of stairs shall lead up to the top of the tanks, with a platform walkway connecting the tops of the three tanks together. Handrails shall be installed around the perimeter of the tank. All stairs, handrails, etc. shall conform to appropriate OSHA requirements.

### Biodiesel Transportation/Delivery

8. Pumps—Three (3) 20 HP Durco Mark III pumps shall be installed inside the diked area to provide a maximum flowrate of 200 gpm each. If, at any time, the biodiesel flow rate cannot keep up with the product loading rate, the Accuload III controllers at the rack are able to shut down flow so that no off-spec blends are allowed.
9. Delivery Piping—Approximately 540 fee of 6″ product piping shall be installed from tanks to the rack, heat traced and insulated. Additionally, 460 fee of 2″ prover return piping shall be installed from the rack to tanks, heated and insulated. A new prover pump will be installed at the facility, if necessary.
10. Heat Tracing—All heat tracing cable is designed to be self-regulating, set to maintain 65 degrees F.
11. Insulation—Product piping to be surrounded by standard 2″ fiberglass insulation. Should the heat tracing around the pipes fail, the insulation could minimize temperature drop to approximately 2 degrees F. per hour. (Uninsulated pipe could drop to ambient temperature in as little as one hour).

Biodiesel Blending
12. Piping in the lanes—The 6″ delivery header shall supply product to the loading lanes, each containing one (1) 4″ piping drop per lane. From the 4″ piping the biodiesel product piping shall split into separate 2″ supply lines, for blending into each metered distillate stream to allow for “hybrid” blending of biodiesel. Hybrid blending involves the biodiesel stream being blended in a ratio manner with other streams which are blending in a sequential manner. To facilitate excellent control of the biodiesel blending stream for the full range from B2 through B20, a 1.5″ v-ball control valve was used.
13. Metering—Each 2″ stream is metered separately using PD meter. The meter was chosen to be a 2″ meter to allow the flexibility to meter over the range from B2 through B20. to better remain within the range of the meter, biodiesel is only blended during the high flow portion of the main component flow.
14. Heat Tracing—The entire piping system is heat traced and insulated from the storage tanks to where the biodiesel stream meets the distillate stream.
15. Mixing—After the point where the biodiesel stream meets the distillate stream, the distillate/biodiesel mixture is passed through a 6″ static mixer, designed to provide the same amount of mixing as seen in laboratory tests.

Biodiesel Receipts
16. Biodiesel Offload Station—A biodiesel offload station may be added to the concrete containment area. The offload station will include a small, self-contained concrete area, designed to contain small drips or sills in the offload area.

FIGS. 1 to 6 also show Operational Considerations. A terminal operates the biodiesel system as follows:
At any given time, two (2) of the four (4) available storage tanks will be aligned for taking receipts ONLY. The remaining two (2) storage tanks will be aligned for delivering biodiesel product to the rack blending system.
This tank alignment ensures that any poor quality biodiesel received from the suppliers can have a greater chance of being detected before being blended and sold to customers.
Pumps, FCV and meter designed & selected to allow blends of B2-B20 from single systems.
Process: Purchase and deliver warm (˜deg F) B100. Maintain heat via insul & heat trace. Blend B100 into ambient petroleum distillate via PD meter & FCV capable of control at wide range of flows to produce B2-B20 biodiesel.

In order to more accurately predict the effects of Biodiesel blending on winter distillate fuels, testing was carried out using neat LSDF and kerosene. Bench-top blending using neat base fuels simulate sequential winter distillate blending and provide results that reinforce the invention. The neat kerosene B2 blends were similar to the LSDF blends, except the wax formation and dissolve time was considerably less. The neat LSDF results showed consistency in the bench-top blending re-creation of the “shock crystallization” effect. The details of these experiments are shown below.

The Examples present analytical results for the blending of 100% Biodiesel with petroleum diesel fuel and kerosene at low temperatures (˜0° F.), in order to obtain a 2% Biodiesel blend with little or no wax formation. The objective was to use neat base fuels, SPP #2 LSDF and #1 fuel oil, to determine sequential winter distillate blending.

### EXAMPLE I

I. Conditions for the first experiment:
100% #1 fuel oil at 0° F.
B100 at 5° F.
1700 rpm agitation for 5 seconds with paddle mixer

### Results

The base fuel was 0° F. before B100 addition. The solution contained a small number of ice crystals but not enough to affect the final results. After the agitation and B100 addition, the solution was allowed to settle for 30-60 seconds. After the air bubbles cleared, very few wax crystals (which quickly dissolved) were observed. The solution was clear and wax free, but with a few ice crystals, just 1-2 minutes after agitation. The base fuel temperature was within the 0-5° F. range throughout the entire experiment.

### EXAMPLE II

II. Conditions for the second experiment:
100% #1 fuel oil at 0° F.
B100 at 50° F.
No agitation

### Results

Two experiments were performed under these conditions in an attempt to produce comparable results. The results are as follows:
Exp. 1 The #1 fuel oil was 0° F., and a small number of water crystals were present prior to B100 addition. B100 (50° F.) was added to the solution while stirring with a thermometer; no additional agitation present. “Shock crystallization” occurred on impact with kerosene, but only a small number of wax crystals formed. After 10-15 minutes, the wax had fully dissolved into the solution. The temperature of the solution was kept in the 0-5° F. range and lightly stirred with a thermometer (only when reading temperature). Due to increasing levels of water crystals during the experiment, it was difficult to determine if and when the wax had fully dissolved.
Exp. 2 The need for confirmation of results was obvious after water crystals infected the solution in the first trial. So, under the same conditions as above, the B100 was added to the #1 fuel oil without agitation (aside from light stirring). This time, no water crystals were present in solution prior to B100 addition, but dissolved rapidly into the #1 fuel oil solution (roughly 5 minutes). Fewer wax crystals formed than in Exp. 1, and dissolve time was much less. The temperature of the solution was kept in the 0-5° range, and no water crystals were present after the wax dissolved, making the determination of dissolve time more accurate.

### EXAMPLE III

III. Conditions for the third experiment:
100% #2 LSDF at 0° F.
B100 at 50° F.
1700 rpm agitation for 5 seconds with paddle mixer

### Results

Small number of water crystals present before B100 addition. The B100 was added during the 5-7 second 1700 rpm agitation. The solution was allowed to settle for one minute after the agitation, in order to better determine the number of wax crystals present. After the solution cleared of air bubbles and the temperature was taken (6° F.), the solution appeared to have more water crystal present, and only a few wax crystals. After 2-3 minutes, what appeared to be wax was dissolved and only water remained. Due to the fact that water crystal formation will increase with Biodiesel addition, it was difficult to discern at what point all wax was dissolved.

### EXAMPLE IV

IV. Conditions for the fourth experiment:
100% #2 LSDF at 20° F.
B100 at 50° F.
No agitation

### Results

The 100% LSDF solution was free of water crystals prior to B100. After B100 addition, a light cloud formed on bottom of flask (as seen when cloud point has been reached), but quickly went away with a light stir. “Shock crystallization” did not occur and after 30 seconds, the solution was clear. The temperature of 20° F. was sufficient to keep “shock crystallization” from occurring in the neat SPP #2 LSDF.

### Conclusion

B2 blending with the neat #1 fuel oil at low temperatures provided favorable results with respect to “shock crystallization”. The results were similar to #2 LSDF blends, except the amount and dissolve time of wax crystals was less. B2 blending in kerosene at 0° F. temperatures with no agitation resulted in wax crystals, but those crystals quickly dissolved. Under the same conditions, agitation at 1700 rpm with a paddle mixer proved to eliminate all wax crystals in a very short time (30 seconds to 2 minutes), which was less time than seen in neat #2 LSDF. The blends made in neat #2 LSDF produced results comparable to previous experiments with similar conditions. A base fuel temperature of 20° F. was sufficient to keep “shock crystallization” from occurring when the B100 was splash blended. Agitation of the solution (#2 LSDF) during blending provided similar results seen in the 70/30 base fuel blends. The wax crystals appear, but dissolve in 2-3 minutes.

### EXAMPLE V

FIG. 7 is a shows Table I which provides a detailed analysis of the pure biodiesel, petroleum diesels, and blends of each used in this invention. The values obtained are within 10% resolution of the test limits.

From the biodiesel blends, the data shows that an improvement in lubricity of diesel can be obtained by utilizing biodiesel at levels as low as 1 Vol %. The blends used have excellent lubricity properties based upon the ASTM D6078 Scuffing Load Ball-in-Cylinder Lubricity Evaluator (SLBOCLE) testing. The SLBOCLE measures the lubricating ability of a fuel sample under controlled conditions where a load arm containing a nonrotating steel ball has weight added to the load arm while a polished steel ring rotates around the steel ball for a fixed amount of time. Weight is added to the load arm until the rotating ring reaches a friction coefficient of 0.175, thus ending the test. A minimum of 3100 grams by the SLBOCLE is considered satisfactory for lubricity protection.

### EXAMPLE VI

FIGS. 8 and 9 show Tables which detail the effects of biodiesel on cetane, lubricity, cloud point, pour point, and CFPP.

A synopsis of observations include:
The biodiesel from one sample had a motor cetane of 53, a viscosity of 5.42 cSt at 40° C., an estimated BTU/Gal of 142,200, and a lubricity value of 6000 grams per SLBOCLE. Other physical properties include a flash point of 255° F. and cold flow properties of 35° F. for pour point, 440 for cloud point, and 38° F. for CFPP. The biodiesel meets all requirements for all evaluated parameters as set forth in ASTM PS-121, the provisional standard for biodiesel.
Other samples also met ASTM D975 specifications based upon the parameters evaluated.
The motor cetane of the petroleum diesel fuels increases an average by 0.2 to 0.3 numbers for every 1 Vol % biodiesel blended.
Lubricity values for the petroleum diesels are found to be exceptional, but are improved by an average of 50 grams on the SLBOCLE test rig for every 2 Vol % biodiesel added. An EMA/TMC recommended fuel specification calls for a minimum of 3100 grams based upon the ASTM D6078 SLBOCLE lubricity test.
Addition of biodiesel lowers the density of the blends, thus improving the gross BTU content of the blends, which theoretically improves fuel economy.
The viscosity values for the petroleum diesel fuels are increased by 0.3 cSt with the addition of 20 Vol % biodiesel.
Biodiesel blending at 10 and 20 Vol % also results in improved thermal stability values.
Pour point increases an average by 1.25° for every 1 Vol % biodiesel blended. At 5 Vol % biodiesel, the diesel exceeds winter pour point requirements. At 1 Vol % biodiesel, the diesel also exceeds requirements for winter diesel.
Cloud point increases range from 0.4 to 0.7° F. per every 1 biodiesel added, depending upon the base diesel. At 20 Vol % biodiesel, both the diesels exceed cloud point maximum winter requirements of +10° F.

### Modifications

Specific compositions, methods, or embodiments discussed are intended to be only illustrative of the invention disclosed by this specification. Variation on these compositions, methods, or embodiments are readily apparent to a person of skill in the art based upon the teachings of this specification and are therefore intended to be included as part of the inventions disclosed herein.

We claim:

1. A method for blending a diesel fuel composition while retaining or improving diesel engine performance comprising the steps of:
providing a major amount of diesel fuel at a temperature of 32° F. or less;
blending a minor amount of biodiesel at a temperature above 32° F. with the diesel fuel; and
producing a resulting diesel fuel composition without shock crystallization.

2. A method for blending a diesel fuel composition while retaining or improving diesel engine performance comprising the steps of:
heating a major amount of diesel fuel to a temperature above 10° F.;
blending a minor amount of biodiesel at a temperature of about 50° F. with the diesel fuel; and
producing a resulting diesel fuel composition without shock crystallization.

3. A method for blending a diesel fuel composition while retaining or improving diesel engine performance comprising the steps of:
providing a major amount of diesel fuel at a temperature of about 0° F.;
blending a minor amount of biodiesel at a temperature below 32° F. with the diesel fuel;
agitating the resulting mixture during the blending; and
producing a resulting diesel fuel composition without shock crystallization.

4. A method according to claim 1 wherein the biodiesel comprises alkyl esters of soybean oil.

5. A method according to claim 1 wherein the biodiesel comprises methyl ester of soybean oil.

6. A method according to claim 1 wherein the resulting diesel fuel composition contains 1 to 20 weight percent biodiesel.

7. A method according to claim 1 wherein the resulting diesel fuel composition is B1, B2, B5, B10 or B20.

8. A method according to claim 1 wherein the resulting diesel fuel composition is wax free.

9. A method according to claim 3 wherein the agitating is carried out at speeds of 12,000 rpm's for a time of 1 to 2 seconds.

10. A method according to claim 3 wherein the agitating is carried out at speeds of 1700 rpm's for a time of 5 to 7 seconds.

11. A diesel fuel composition produced by the process of claim 1.

12. A diesel fuel composition produced by the process of claim 2.

13. A diesel fuel composition produced by the process of claim 3.

14. An apparatus for blending a diesel fuel composition of diesel fuel and biodiesel while retaining or improving diesel engine performance comprising:
a biodiesel tank for supplying biodiesel;
a biodiesel tank heater for heating the biodiesel;
a pump for removing heated, biodiesel from the biodiesel tank;
a mixer for blending the heated biodiesel and diesel fuel;
delivery piping for delivering heated biodiesel from the pump to the mixer;
a source of diesel fuel;
metering piping for delivering diesel fuel to the mixer; and
an offload station for removing the resulting diesel fuel composition from the mixer.

15. An apparatus according to claim 14 wherein the mixer is a static mixer.

16. An apparatus according to claim 14 wherein the mixer is a Braun hand mixer.

17. An apparatus according to claim 14 wherein the mixer is a paddle mixer.
